(19) United States
(12) Patent Application Publication
(10) Pub. No.: US 2021/0019256 A1
(43) Pub. Date: Jan. 21, 2021

(54) DATA REALIGNMENT FOR HARDWARE ACCELERATED OPERATIONS

(71) Applicant: International Business Machines Corporation, Armonk, NY (US)

(72) Inventors: Brad Stilwell, Poughkeepsie, NY (US); Anthony Thomas Sofia, Hopewell-Junction, NY (US)

(21) Appl. No.: 16/511,033

(22) Filed: Jul. 15, 2019

(51) Int. Cl. G06F 12/06

(52) U.S. Cl. CPC G06F 12/0646; G06F 2212/7202

(57) ABSTRACT

An aspect includes a method for aligning memory includes copying application data stored in first page-aligned memory addresses to unaligned memory addresses with a saved offset defining the first page-aligned memory addresses respective to a page table. The method includes copying the application data stored in the unaligned memory addresses to second page-aligned memory addresses when a modulo operation based on the saved offset and a page size associated with the page table is nonzero. The method includes updating the saved offset with the second page-aligned memory addresses respective to the page table.

### BACKGROUND

The present disclosure relates to data realignment, and more specifically, to hardware accelerated operations related to unaligned data.

### SUMMARY

Embodiments include methods and systems for memory alignment. A method for aligning memory includes copying application data stored in first page-aligned memory addresses to unaligned memory addresses with a saved offset defining the first page-aligned memory addresses respective to a memory allocation within a page table. The method includes performing a modulo operation based on the saved offset and a page size associated with the page table in response to copying application data stored in the first page-aligned memory addresses. The method includes copying the application data stored in the unaligned memory addresses to second page-aligned memory addresses based on a result of the modulo operation being nonzero. The method includes updating the saved offset with the second page-aligned memory addresses respective to the page table.

Embodiments also include a computer system having physical memory with physical memory addresses. The computer system includes virtual memory addresses mapped to the physical memory addresses according to a page table. The page table defines a page size defining first page-aligned memory addresses and second page-aligned memory addresses aligned with the page size, and unaligned memory addresses unaligned with the page size. The computer system includes hardware acceleration circuitry configured to access application data of the virtual memory addresses. The computer system includes a user program stored within the virtual memory addresses operable upon execution by the computer to copy the application data to unaligned memory addresses of the virtual memory addresses, and copy the application data stored in the unaligned memory addresses to second page-aligned memory addresses when a modulo operation based on a saved offset associated with the first page-aligned memory address and a page size associated with the page table is nonzero.

Embodiments also include a computer system including physical memory having physical memory addresses. The computer system includes hardware acceleration circuitry configured to access application data stored on the physical memory and arranged according to virtual memory addresses. The virtual memory addresses are mapped to the physical memory addresses based on a page table. The page table defines a page size defining first page-aligned memory addresses and second page-aligned memory addresses aligned with the page size. The page table defines unaligned memory addresses unaligned with the page size. The computer system includes a user program stored within the virtual memory addresses operable upon execution by the computer system to copy the application data to unaligned memory addresses of the virtual memory addresses, and copy the application data stored in the unaligned memory addresses to second page-aligned memory addresses when a modulo operation based on a saved offset and a page size associated with the page table is nonzero.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 illustrates a block diagram of components of a page table relating virtual memory addresses to physical memory addresses in accordance with one or more embodiments;

FIG. 2 illustrates aligned and unaligned memory addresses with respect to a page table in accordance with one or more embodiments;

FIG. 3 illustrates a flow diagram of a process for aligning memory associated with a page table in accordance with one or more embodiments; and

FIG. 4 illustrates a computer system for aligning memory associated with a page table and including hardware acceleration circuitry in accordance with one or more embodiments.

### DETAILED DESCRIPTION

Embodiments described herein provide a method for aligning memory of computer systems. One or more embodiments of the present invention may include operating system application programming interfaces (APIs) that require the caller or user application to provide a memory buffer that is used as a state area by the API. For some callers or user applications it is difficult for memory to be obtained on an aligned boundary, so the API will just accept an area with any alignment. Memory alignment may be required for additional system services or hardware acceleration and such original memory allocation may be used as a buffer for those services.

As used herein, the term memory is used to refer to any device capable of storing data such as, but not limited to a dynamic random-access memory (DRAM) device or a flash memory device. The physical memory device includes memory addresses that define memory locations for storing data and the physical memory device may be associated with virtual memory. The virtual memory may include virtual memory addresses corresponding to the physical memory addresses through a page table that defines the relationship between physical memory addresses and virtual memory addresses. The page table may be stored in the physical memory or another location and may be defined by pages having a page size. Each page has a start address defining the start of the page and an end address defining the end of the page. Associated data stored at the start of the page may be termed page-aligned. Page alignment may provide enhanced efficiency for data reading, writing, and execution.

A user application or program may have direct access to the virtual memory through operating system (OS) APIs. The OS APIs may allow the user application to copy portions of data from page-aligned virtual memory addresses to other virtual memory addresses. The other virtual memory addresses may be unaligned. When unaligned virtual memory addresses are used, the efficiency of reading or writing such data may be reduced or otherwise impaired.

Hardware acceleration circuitry may be configured to perform the operations on application data only when the application data is stored in page-aligned memory addresses. The hardware acceleration circuitry may perform some functions more efficiently than the user program would otherwise perform the operations. The conjunctive sharing of the same data, for hardware acceleration and user programs may cause memory to become unaligned. As such, realignment of such memory stores may improve the overall performance of cooperative operations.

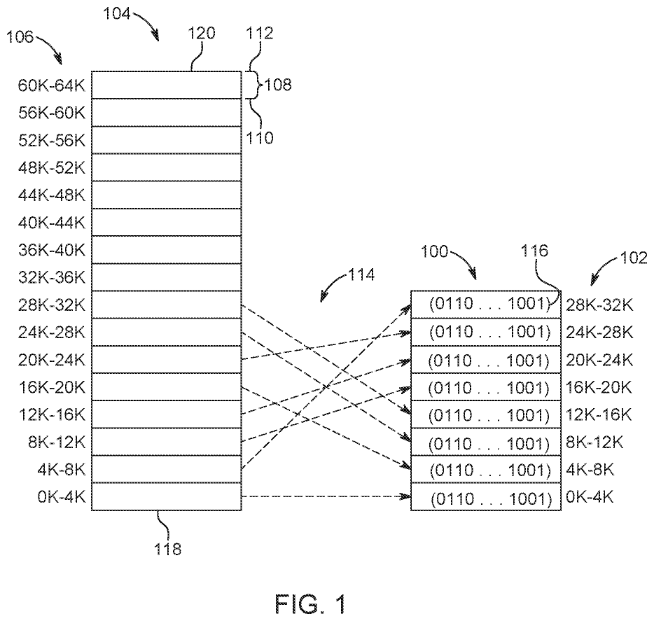

Turning to FIG. 1, physical memory 100 is shown in accordance with one or more embodiments of the present invention. The physical memory 100 includes physical memory addresses 102 defining data repositories associated with the physical memory 100. A page table 104 translates virtual memory addresses 106 to the physical memory addresses 102. The page table 104 includes pages 108 having a page starting address 110 and a page ending address 112, and the pages 108 shown in FIG. 1, as an example, are defined by the page starting address 110 and the page ending address 112. For example, the page 108 may be 4 kilobytes (Kb) as shown. The page 108 may have any number of associated bytes.

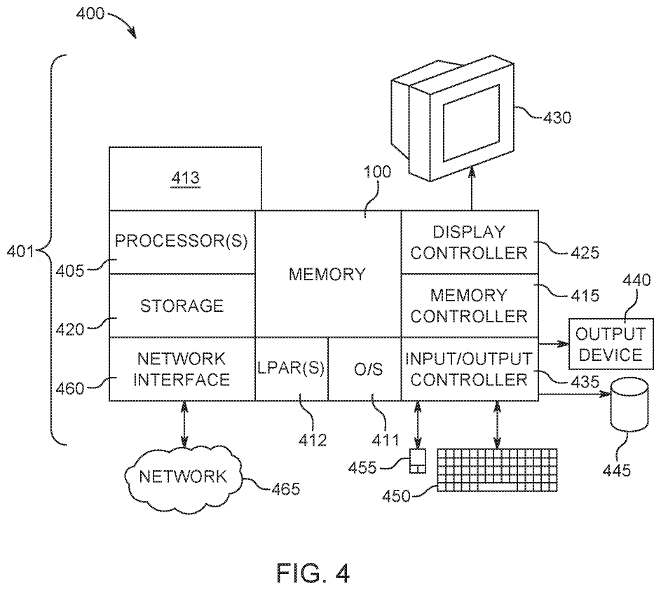

Those of skill in the art will readily appreciate that the page size from the page starting address 110 to the page ending address 112 may be arbitrarily set and vary within the page table 104. The page starting address 110 pertaining to the page 108 may be defined as the 60K memory location and the page ending address 112 may be defined as the 64K memory location, providing a 4K or 4 Kb page (memory quantities or numerical locations). The page 108 may include physical memory locations of the applicable application data 116. The application data 116 may be available through memory buses to hardware acceleration circuitry 413, as shown in FIG. 4, or user applications. As shown in FIG. 1, page table 104 is defined by a page table starting address 118 of OK and a page table ending address 120 of 64K. Translation paths 114 indicate the corresponding physical memory addresses 102 associated with virtual memory addresses 106. It should be appreciated that one or more embodiments of the present invention may be interchangeably related to physical memory or virtual memory.

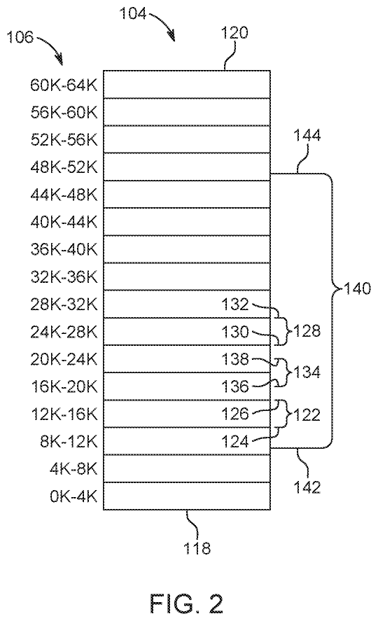

Turning to FIG. 2, page table 104 is shown having virtual memory addresses 106 in accordance with one or more embodiments. The virtual memory addresses 106 shown in FIG. 2 define pages 108.

A memory allocation command may be called by the user application as part of an API to allocate a memory allocation 140 of the page table 104 to the user application. The memory allocation 140 may include a memory allocation starting memory location 142 defined in page table 104 and a memory allocation ending location 144 defined in page table 104. The memory allocation 140 may include first page-aligned memory addresses 122, second page-aligned memory addresses 128, and unaligned memory addresses 134.

First page-aligned memory addresses 122 are shown. The first page-aligned memory addresses 122 may be padded or extended to fit the entirety of a page 108 or pages 108 or have a first page-aligned start address 124 based on or aligned with the page starting address 110 of any one of the pages 108. The first page-aligned memory address 122 may include a first page-aligned end address 126. The first page-aligned end address 126 may be based on the page ending address 112 of one of the pages 108. An offset may be saved as a saved offset based on the page table starting address 118 with respect to the first page-aligned memory addresses 122. For example, the saved offset stored in the application data 116 may be 12K.

Second page-aligned memory addresses 128 are also shown in FIG. 2. The second page-aligned memory addresses 128 may be padded or extended to fit an entire page 108 or have a second page-aligned start address 130 based on or aligned with the page starting address 110 of any one of the pages 108. The second page-aligned memory addresses 128 may include a second page-aligned end address 132. The second page-aligned end address 132 may be based on the page ending address 112 of one of the pages 108. An offset may be saved as a saved offset based on the page table starting address 118 with respect to the second page-aligned memory addresses 128. For example, the saved offset stored in the application data 116 may be 24K.

Still referring to FIG. 2, unaligned memory addresses 134 are shown. The unaligned memory addresses 134 have an unaligned start address 136 that is not based on, aligned with, or equal to the page starting address 110 of a page 108. As just one example, the unaligned memory addresses 134 may have an unaligned start address 136 that is between two pages 108 and overlap one of the page starting addresses 110 or page end addresses 112 such that the unaligned ending address 138 is disposed within another of the pages 108. An offset may be saved as a saved offset based on the page table starting address 118 with respect to the second page-aligned memory addresses 128. For example, the saved offset stored in the application data 116 may be 18K.

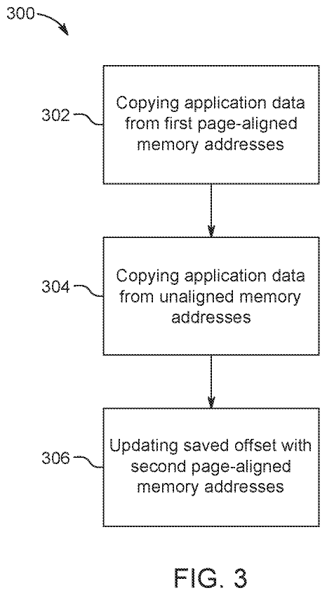

Referring to FIG. 3, a method 300 for data realignment is generally shown in accordance with one or more embodiments. In block 302, the method 300 includes copying application data stored in first page-aligned memory addresses 122. Those versed in the art will readily appreciate that application data 116 may be combination of information, binary encoded or otherwise, stored in the physical memory 100 as assigned by the page table 104. The application data may be defined by or associated with a user program stored in the physical memory 100.

Those versed in the art will readily appreciate that a program, application, user program, or other instruction set may be defined as any set of instructions and combination of data executable by a computer system 400 or processor 405, as shown in FIG. 4, associated with the memory through buses or other systems. In accordance with one or more embodiments of the present disclosure, the user program often includes or calls an API having subroutines configured to call the hardware acceleration circuitry 413. The hardware acceleration circuitry 413 may be part of the processor(s) 405 or independently access the application data 116 stored in the physical memory 100. The application data 116 may be copied to unaligned memory addresses 134 with a saved offset. The saved offset may be a memory address, virtual or otherwise. The saved offset may be defined relative to a first memory or starting memory address. The page table starting address 118 may be start at memory location zero or another memory location associated with the page table 104 or the physical memory 100.

In block 304, the method 300 includes copying the application data 116 stored in the unaligned memory addresses 134 to second page-aligned memory addresses 128. The user application may request that the application data 116 stored in the first page-aligned memory addresses 122 be copied to any memory address. The processor or computer may determine that the application data 116 has been copied to unaligned memory addresses 134 by performing a modulo operation or a calculation. If a modulo operation based on the saved offset and a page size associated with the page table 104 is nonzero, the application data is unaligned and is copied into proper alignment by the processor.

A modulo operation may be any operation that includes division by a modulus. In accordance with one or more embodiments of the present disclosure, the modulus may oft be the page size defined by the page starting address 110 and the page ending address 112. The modulo result is the remainder of the modulo operation or any other numeric value. The second page-aligned memory addresses 128 may have a value greater than the unaligned memory addresses 134 when the modulo result is greater than half the page size. As one non-limiting example, the second page-aligned memory addresses 128 may be numerically greater than the unaligned memory addresses 134 when the modulo result or remainder of the modulo operation is greater than half of the page size, indicating that the application data 116 should be moved to a greater in magnitude starting memory address because it is the closest page-aligned starting memory address available. As one non-limiting example, the second page-aligned memory addresses 128 may be numerically less than the unaligned memory addresses 134 when the modulo result or remainder of the modulo operation is less than half of the page size, indicating that the application data 116 should be moved to a lessor in magnitude starting memory address because it is the closest page-aligned starting memory address available.

In block 306, the saved offset is updated with the second page-aligned memory addresses 128 respective to the page table 104. That is, the offset of the start of the second page-aligned memory addresses 128 may be stored in the physical memory 100. The copying of the application data 116 from the first page-aligned memory addresses 122 or from the unaligned memory addresses 134 may be responsive to receiving a copy request from a user application. The copy request may be part of an application programming interface with hardware or a kernel of the computer system. The application programming interface may allow the user application to interface with hardware or the operating system 411.

The user application stored in the physical memory 100 may send a hardware acceleration request to the processor such that hardware acceleration circuitry is used to manipulate the user application data. The modulo operation may include the page table starting address 118. The modulo operation may be a summation of the page table starting address 118 and the saved offset in relation to the unaligned memory addresses 134. The resulting summation modulo the page size of the pages 108 may indicate that unaligned memory addresses 134 are not aligned with the pages 108. The user program directs storage of the application data 116 in the first page-aligned memory addresses 122. The second page-aligned memory address 128 may include a second page-aligned end address 132. The second page-aligned end address 132 may be based on the page ending address 112 of the page 108. As an example, the page ending address 112 may be 8K, and as such, the second page-aligned memory address 128 may be defined as the page ending address 112.

Turning now to FIG. 4, a computer system 400 for performing memory alignment is generally shown. The methods described herein can be implemented in hardware, software (e.g., firmware), or a combination thereof. The computer system 400 therefore may include general-purpose mainframe or computer 401 capable of running multiple instances of an O/S simultaneously.

In terms of hardware architecture, as shown in FIG. 4, the computer 401 includes one or more processors 405, physical memory 100 coupled to a memory controller 415, and one or more input and/or output (I/O) devices 440, 445 (or peripherals) that are communicatively coupled via a local input/output controller 435. The memory controller 415 may maintain the virtual memory addresses 106 and the page table 104. The input/output controller 435 can be, for example but not limited to, one or more buses or other wired or wireless connections, as is known in the art. The input/output controller 435 may have additional elements, which are omitted for simplicity, such as controllers, buffers (caches), drivers, repeaters, and receivers, to enable communications. Further, the local interface may include address, control, and/or data connections to enable appropriate communications among the aforementioned components. The input/output controller 435 may include a plurality of sub-channels configured to access the output devices 440, 445. The sub-channels may include fiber-optic communications ports.

The processor 405 is a hardware device for executing software such as a user application, stored in storage 420, such as cache storage, or physical memory 100. The processor 405 can be any custom made or commercially available processor, a central processing unit (CPU), an auxiliary processor among several processors associated with the computer 401, a semiconductor based microprocessor (in the form of a microchip or chip set), a microprocessor, or generally any device for executing instructions.

The physical memory 100 can include any one or combination of volatile memory elements (e.g., random access memory (RAM, such as DRAM, SRAM, SDRAM, etc.)) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the physical memory 100 may incorporate electronic, magnetic, optical, and/or other types of storage media. Note that the physical memory 100 can have a distributed architecture, where various components are situated remote from one another, but can be accessed by the processor 405.

The computer system 400 may include hardware acceleration circuitry 413. The hardware acceleration circuitry 413 may provide vector-based operations to improve mathematical operations on the application data 116. The hardware acceleration circuitry 413 may be configured to perform operations on the application data 116. The hardware acceleration circuitry may be configured to perform the operations on the application data 116 only when the application data is stored in page-aligned memory addresses. The hardware acceleration circuitry 413 may perform some functions more efficiently than the user program would otherwise perform the operations. The conjunctive sharing of the same application data 116, for hardware acceleration and user programs may cause memory to become unaligned. As such, realignment of such memory stores may improve the overall performance of cooperative operations.

The instructions in physical memory 100 may include one or more separate programs, each of which comprises an ordered listing of executable instructions for implementing logical functions. In the example of FIG. 4, the instructions in the physical memory 100 a suitable operating system (OS) 411. The operating system 411 essentially controls the execution of other computer programs and provides scheduling, input-output control, file and data management, memory management, and communication control and related services.

The physical memory 100 may include multiple logical partitions (LPARs) 412, each running an instance of an operating system. The LPARs 412 may be managed by a hypervisor, which may be a program stored in physical memory 100 and executed by the processor 405.

A conventional keyboard 450 and mouse 455 can be coupled to the input/output controller 435. Other output devices such as the I/O devices 440, 445 may include input devices, for example but not limited to a printer, a scanner, microphone, and the like. Finally, the I/O devices 440, 445 may further include devices that communicate both inputs and outputs, for instance but not limited to, a network interface card (MC) or modulator/demodulator (for accessing other files, devices, systems, or a network), a radio frequency (RF) or other transceiver, a telephonic interface, a bridge, a router, and the like. The computer system 400 can further include a display controller 425 coupled to a display 430. The computer system 400 can further include a network interface 460 for coupling to a network 465. The network 465 can be an IP-based network for communication between the computer 401 and any external server, client and the like via a broadband connection. The network 465 transmits and receives data between the computer 401 and external systems. In an exemplary embodiment, network 465 can be a managed IP network administered by a service provider. The network 465 may be implemented in a wireless fashion, e.g., using wireless protocols and technologies, such as WIFI, WIMAX, etc. The network 465 can also be a packet-switched network such as a local area network, wide area network, metropolitan area network, Internet network, or other similar type of network environment. The network 465 may be a fixed wireless network, a wireless local area network (LAN), a wireless wide area network (WAN) a personal area network (PAN), a virtual private network (VPN), intranet or other suitable network system and includes equipment for receiving and transmitting signals.

The computer 401 may be a PC, workstation, intelligent device or the like, including instructions in the physical memory 100 that may further include a basic input output system (BIOS) (omitted for simplicity). The BIOS is a set of essential software routines that initialize and test hardware at startup, start the OS 411, and support the transfer of data among the hardware devices. The BIOS is stored in ROM so that the BIOS can be executed when the computer 401 is activated.

When the computer 401 is in operation, the processor 405 is configured to execute instructions stored within the physical memory 100, to communicate data to and from the physical memory 100, and to generally control operations of the computer 401 pursuant to the instructions.

In an exemplary embodiment, the methods described herein can be implemented with any or a combination of the following technologies, which are each well known in the art: a discreet logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for aligning memory, comprising:
copying application data stored in first page-aligned memory addresses to unaligned memory addresses with a saved offset defining the first page-aligned memory addresses respective to a memory allocation within a page table;
performing a modulo operation based on the saved offset and a page size associated with the page table in response to copying application data stored in the first page-aligned memory addresses;
copying the application data stored in the unaligned memory addresses to second page-aligned memory addresses based on a result of the modulo operation being nonzero; and
updating the saved offset with the second page-aligned memory addresses respective to the page table.

2. The method for aligning memory of claim 1, wherein the second page-aligned memory addresses have a value greater than the unaligned memory addresses when a modulo result of the modulo operation is greater than half the page size.

3. The method for aligning memory of claim 1, further comprising receiving a hardware acceleration request from a user application.

4. The method for aligning memory of claim 3, wherein the user application defines a memory allocation starting address and the modulo operation is further based on the memory allocation starting address.

5. The method for aligning memory of claim 4, wherein the modulo operation is a summation of the memory allocation starting address and the saved offset, and the summation modulo the page size.

6. A computer system comprising:
physical memory having physical memory addresses;
virtual memory addresses mapped to the physical memory addresses according to a page table, the page table defining a page size defining first page-aligned memory addresses and second page-aligned memory addresses aligned with the page size, and unaligned memory addresses unaligned with the page size;
hardware acceleration circuitry configured to access application data of the virtual memory addresses; and
a user program stored within the virtual memory addresses operable upon execution by the computer to copy the application data to unaligned memory addresses of the virtual memory addresses, and copy the application data stored in the unaligned memory addresses to second page-aligned memory addresses when a modulo operation based on a saved offset associated with the first page-aligned memory addresses and a page size associated with the page table is nonzero.

7. A computer system of claim 6, wherein the user program directs storage of the application data in the first page-aligned memory addresses.

8. A computer system of claim 6, wherein the hardware acceleration circuitry is configured to perform operations on the application data.

9. A computer system of claim 8, wherein the hardware acceleration circuitry is configured to perform the operations on the application data only when the application data is stored in page-aligned memory address.

10. A computer system of claim 9, wherein the operations are vector-based mathematical operations.

11. A computer system of claim 6, wherein the user program is an application programming interface having subroutines configured to call the hardware acceleration circuitry.

12. A computer system of claim 6, wherein the modulo operation has a modulo defined by the page size and a modulo result.

13. A computer system of claim 12, wherein the second page-aligned memory addresses are based on the modulo result.

14. A computer system of claim 13, wherein the second page-aligned memory addresses have a value greater than the unaligned memory addresses when the modulo result is greater than half the page size.

15. A computer system of claim 13, wherein the second page-aligned memory addresses have a value less than the unaligned memory addresses when the modulo result is less than half the page size.

16. A computer system comprising, comprising:
physical memory having physical memory addresses;
hardware acceleration circuitry configured to access application data stored on the physical memory and arranged according to virtual memory addresses mapped to the physical memory addresses based on a page table, the page table defining a page size defining first page-aligned memory addresses and second page-aligned memory addresses aligned with the page size, and unaligned memory addresses unaligned with the page size; and
a user program stored within the virtual memory addresses operable upon execution by the computer system to copy the application data to unaligned memory addresses of the virtual memory addresses, and copy the application data stored in the unaligned memory addresses to second page-aligned memory addresses when a modulo operation based on a saved offset and a page size associated with the page table is nonzero.

17. A computer system of claim 16, wherein the modulo operation has a modulo defined by the page size and a modulo result.

18. A computer system of claim 17, wherein the second page-aligned memory addresses are based on the modulo result.

19. A computer system of claim 18, wherein the second page-aligned memory addresses have a value greater than the unaligned memory addresses when the modulo result is greater than half the page size.

20. A computer system of claim 16, wherein the user program directs storage of the application data in the first page-aligned memory addresses.
